(19) United States
(12) Patent Application Publication
(10) Pub. No.: US 2024/0018782 A1
(43) Pub. Date: Jan. 18, 2024

(54) SYSTEM, METHOD AND APPARATUS FOR VENTED BIRD STOP WITH EMBER STOP

(71) Applicant: PACIFIC AWARD METALS, INC., Baldwin Park, CA (US)

(72) Inventors: David Starr, Burton, WA (US); Hans Matheus, Fresno, CA (US); Steven Saffron, Monrovia, CA (US)

(73) Assignee: PACIFIC AWARD METALS, INC., Baldwin Park, CA (US)

(21) Appl. No.: 18/219,589

(22) Filed: Jul. 7, 2023

Related U.S. Application Data
(60) Provisional application No. 63/388,689, filed on Jul. 13, 2022.

(51) Int. Cl. E04D 1/30

(52) U.S. Cl. CPC E04D 1/30; E04D 2001/309

(57) ABSTRACT

A roof system can include a roof deck that supports roof tiles. The roof system can further include a bird stop to support a first course of the roof tiles adjacent an eave of the roof deck. The bird stop can be solid and have apertures. Each aperture can include a through hole and a deformed portion behind a respective through hole. Each through hole can have a length and a width. At least one of the length and width can have a maximum dimension of not greater than ⅛ inch.

### CROSS-REFERENCE TO RELATED APPLICATION

This application claims priority to and the benefit of U.S. Prov. Pat. App. No. 63/388,689, filed Jul. 13, 2022, which is incorporated herein by reference in its entirety.

### BACKGROUND

### Field of the Disclosure

The present disclosure relates in general to roofing technologies and, in particular, to a roofing-related bird stop that is vented and can still stop embers from fire from entering the bird stop.

### Description of the Prior Art

Roofing systems typically absorb and conduct heat from sunlight, depending on composition. Most roofing systems raise the temperature of the attic space under the roof assembly. Traditional attic spaces have been ventilated in many ways over the years. Tile roof assemblies (e.g., those formed from ceramic, clay, cement, etc.) typically are constructed with an air space under the tiles and above the roof deck to better manage heat.

Building Integrated Photo Voltaic (BIPV) solar panels can generate even more heat. Unfortunately, solar panel efficiency significantly drops as the internal panel temperatures increase. Solar panels that are installed on a tile roof can face challenging heat management issues. To mitigate heat, a bird stop/tile riser can be installed along the lowermost edge of a tile roof. Another purpose for the bird stop/tile riser is to support the first course of tile in a tile roof. Structural function or tile alignment of a tile roof can be compromised if the tile roof is carelessly perforated when solar panels are installed on it.

Wildland Urban Interfaces are becoming more common as real estate development expands beyond the suburbs of cities. Wildfires are a unique heat storm with flying embers and sparks. The dramatic temperature differentials between air spaces inside structures, attic, or roof systems, and outside air during wildfire, can become supercharged and the intakes can effectively develop into a blowtorch. Although some existing solutions are workable, improvements in roofing systems continue to be of interest.

### SUMMARY

Embodiments of a roofing system are disclosed. For example, the roofing system can include a roof deck that supports roofing tiles. The roofing system can further include a bird stop that supports a first course of the roofing tiles adjacent to an eave of the roof deck. The bird stop can be solid and comprise a plurality of apertures. Each aperture can include a through hole and a deformed portion behind a respective through hole. Each through hole can have a length and a width. At least one of the length and width can have a maximum dimension of not greater than ⅛ inch.

### BRIEF DESCRIPTION OF THE DRAWINGS

Before one or more embodiments are described in detail, one skilled in the art will appreciate that they are not limited in its application to the details of construction, the arrangements of components, and the arrangement of steps set forth in the following detailed description or illustrated in the drawings and descriptions. Rather, they are capable of other embodiments and of being practiced or being carried out in various ways. Also, it is to be understood that the phraseology and terminology used herein is for the purpose of description and should not be regarded as limiting.

FIG. 1 is a perspective view of embodiments of a bird stop.

FIG. 2 is a perspective view of another embodiment of a bird stop.

FIGS. 3A and 3B are perspective views of still other embodiments of a bird stop.

FIG. 4 is a plan view of an embodiment of an aperture layout for a bird stop.

FIGS. 5A, 5B and 5C are sectional side views of embodiments of a single aperture in the bird stop of FIG. 4, taken along the line 5-5 of FIG. 4.

FIGS. 6A and 6B are sectional end views of embodiments of a single aperture in the bird stop of FIG. 4, taken along the line 6-6 of FIG. 4.

FIG. 7 is a perspective view of an embodiment of a roof system, including solar panels.

FIGS. 8-9 are perspective views of additional embodiments of bird stops.

FIG. 10 is a schematic, perspective diagram of an embodiment of a bird stop installed in a roof.

FIG. 11 is a perspective view of another embodiment of a bird stop installed in a roof.

### DETAILED DESCRIPTION

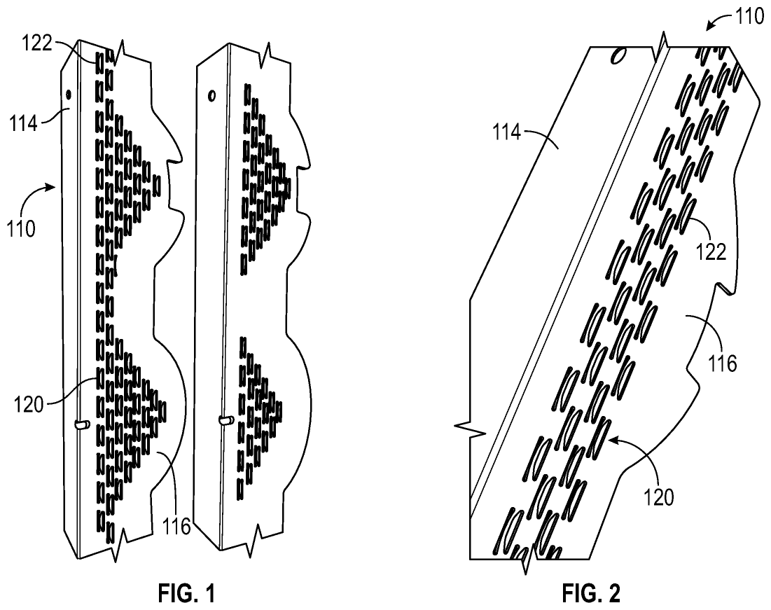

Referring to FIGS. 1-11, the following descriptions of various implementations of the present teachings have been presented for purposes of illustration and description. It is not exhaustive and does not limit the present teachings to the precise forms disclosed. Modifications and variations are possible in light of the above teachings or may be acquired from practicing of the present teachings.

Embodiments of a roofing system 100 (FIGS. 7, 10 and 11) can include a roof deck 102 that supports roofing structures, such as tiles 104 and solar panels 106. The roofing system 100 can comprise one or more bird stops 110 (FIGS. 1-3, 10 and 11) that are configured to support a first course of the roofing tiles 104 adjacent to an eave 112 of the roof deck 102. The bird stop 110 can include a mounting flange 114, which can be rectangular, at a lower portion thereof that engages and is coupled to the roof deck 102, such as with fasteners. Each bird stop 110 can comprise a bird stop, an eave closure and/or a tile riser.

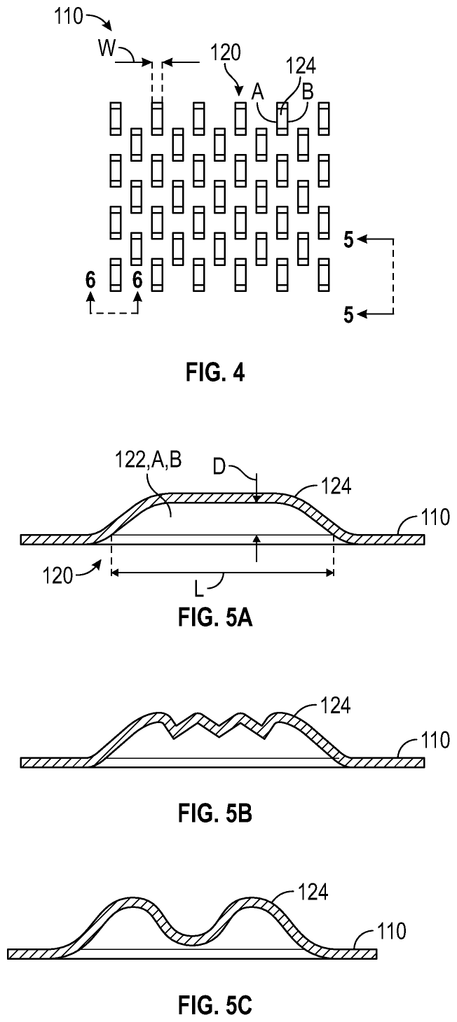

Each bird stop 110 can be solid and comprise a plurality of apertures 120. Each aperture 120 can comprise a through hole 122 and a deformed portion 124. The deformed portion 124 can be behind or in front of a respective through hole 122. As shown in FIGS. 4-5, each through hole 122 can include a length L, a width W and a depth D. At least one of the width W and/or depth D can comprise a maximum dimension of not greater than ⅛ inch, for example. The deformed portion 124 can extend outward, away from the roofing tiles 104 toward the gutter or outer perimeter at the eave 112 of the roofing system 100. Alternatively, the deformed portion 124 can extend inward, toward and beneath the roofing tiles 104. Alternatively, the deformed portion 124 may extend outward.

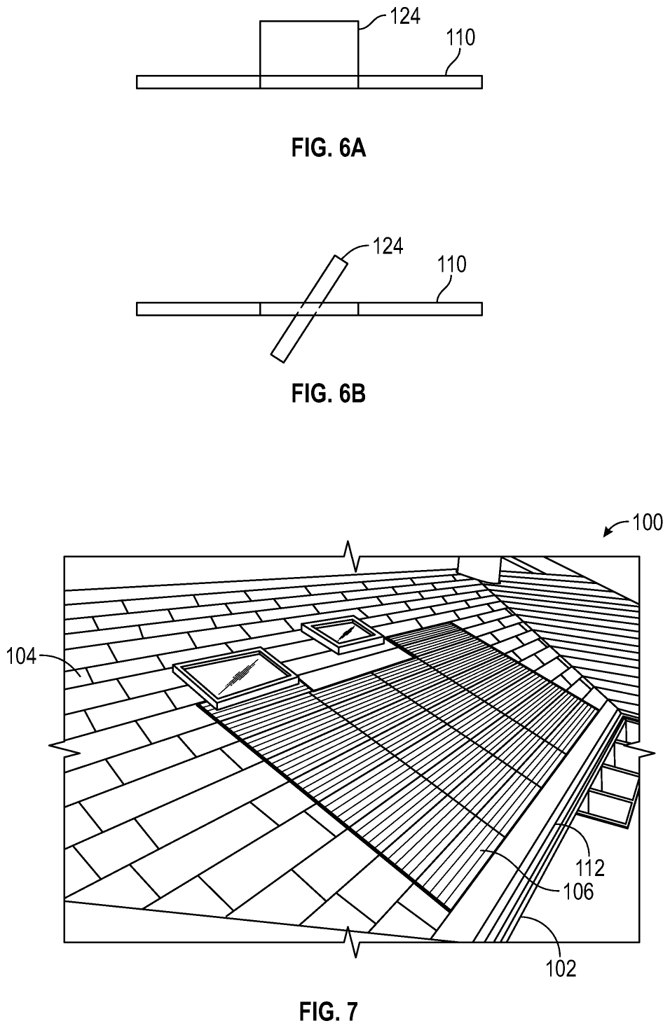

In some embodiments, a depth D (FIG. 5A) can extend between an edge of each through hole 122 and an inner edge of a respective deformed portion 124. The depth D can be not greater than 1/20 inch, in some versions. Each deformed portion 124 can be open and unobstructed both above and below A, B of the deformed portion 124. Alternatively, the deformed portions 124 may be oriented vertically so that they are open and unobstructed along their vertical sides. The deformed portion 124 can comprise a trapezoidal shape (FIG. 5A) or other shapes. Each through hole 122 can be rectangular (FIG. 1), lenticular (FIG. 2) or other shapes (see FIGS. 5B, 5C, 6A and 6B).

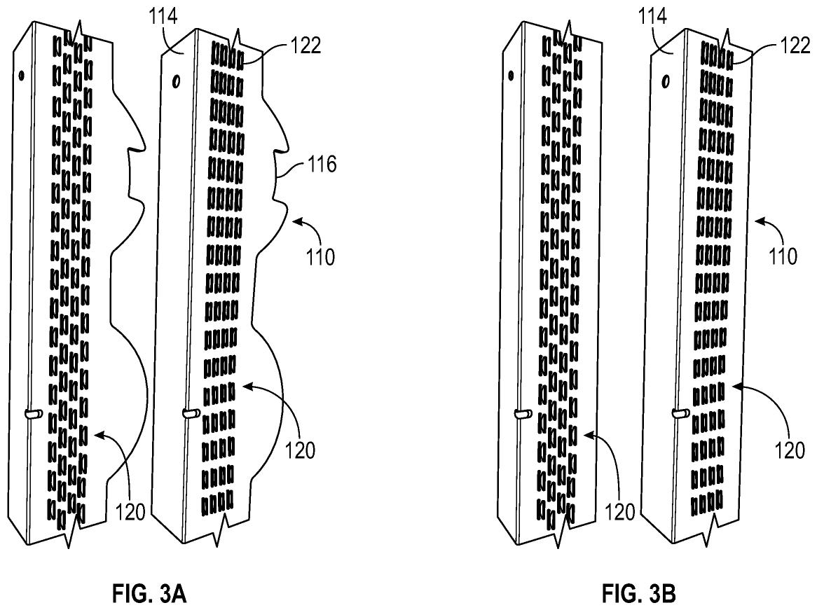

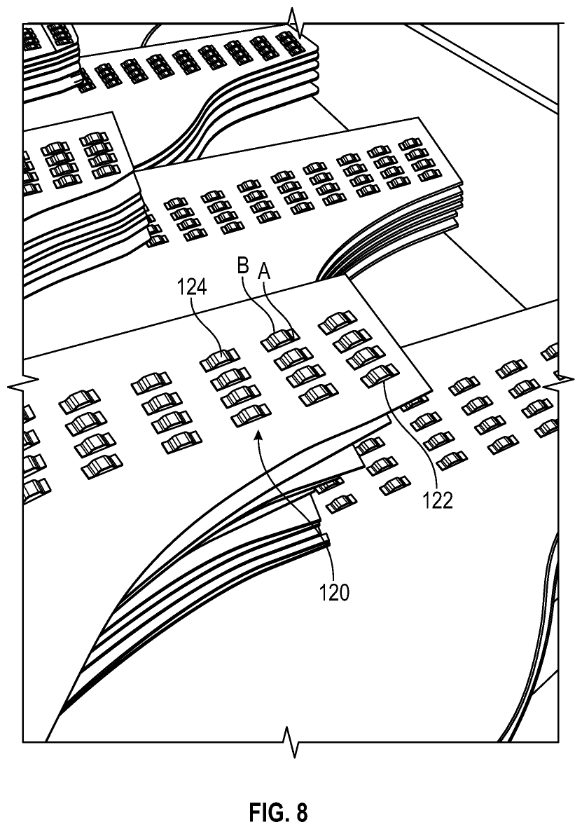

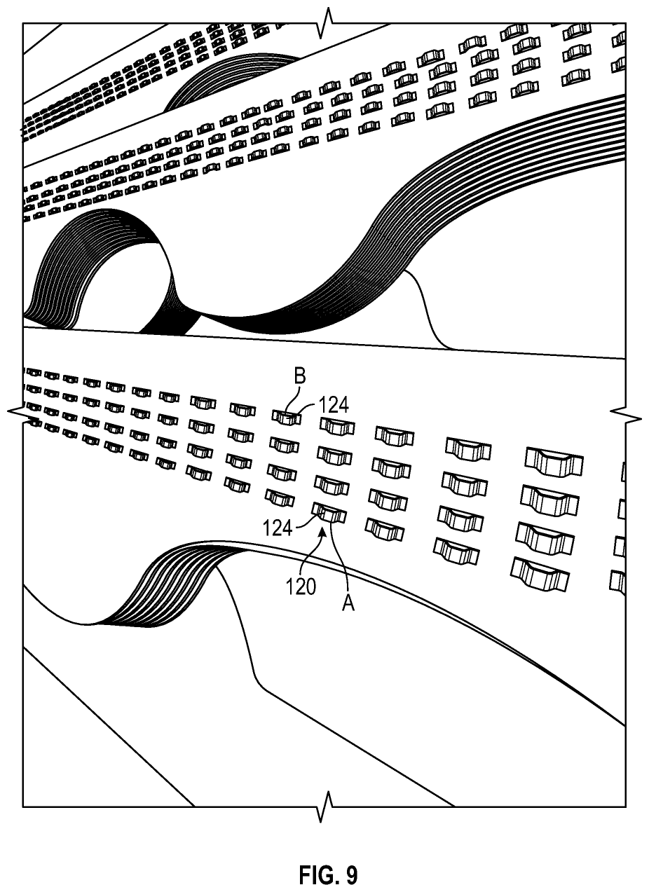

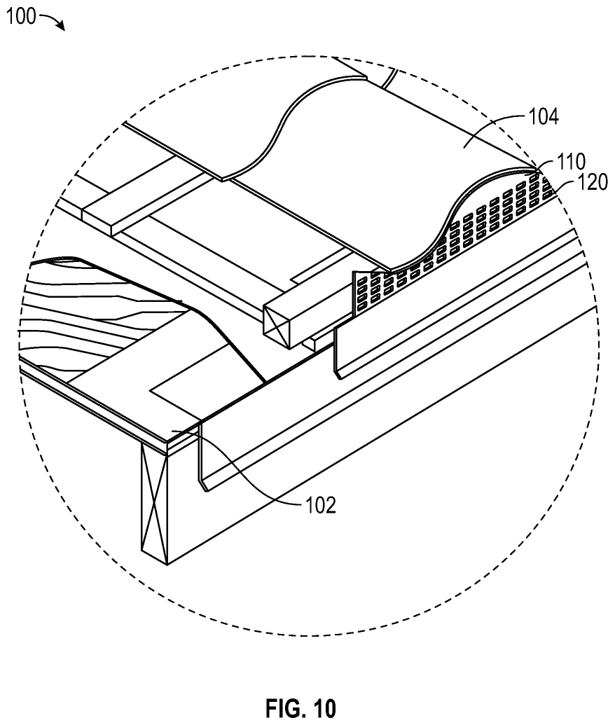

As shown on the left side of FIG. 1, the apertures 120 can comprise triangular array patterns that can be connected by other apertures 120. On the right side of FIG. 1, the triangular arrays are not connected by other apertures 120. FIG. 2 depicts a staggered, alternating array of apertures 120. FIG. 3 depicts still other shapes of apertures 120. In another version (FIGS. 8-9), the array of apertures 120 may comprise four even or uneven (staggered) rows of apertures 120.

In addition, the bird stop 110 can comprise an upper contour 116 that is configured to structurally support an underside of the first course of roofing tiles 104. The upper contour 116 and the underside of the roofing tiles 104 can be complementary in shape, as shown. Alternatively, the bird stops 110 can be used beneath and support the leading edges of solar panels, such as solar panels elevated above roofing products, or those solar panels that are integrated directly on roofing products, such as ceramic tiles.

Some versions of the roofing system 100 do not comprise a mesh, screen or backing material adjacent to the apertures 120. Some examples of the roofing system do not comprise louvers. The term “louver” is defined as a single covering for an aperture that has only one opening, rather than two openings (e.g., via lancing or stamping) like the embodiments disclosed herein.

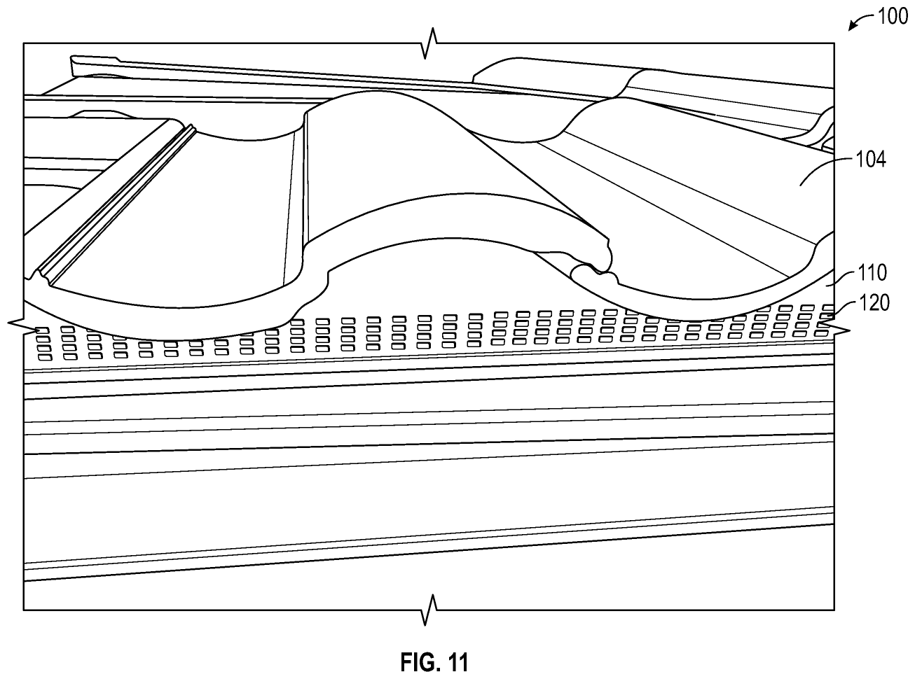

As shown in FIGS. 10-11, embodiments of the roofing system 100 can include bird stops 110 that can support the underside of and ventilate the roof tiles and/or solar panels 106, such as Building Integrated Photo Voltaic (BIPV) solar panels.

Precision tooling can be applied to bird stop or tile riser panels 110. The bird stops 110 can have openings that are small enough to block burning embers, allow significant air intake between tiles and a roof deck, and provide cooling under tiles or BIPV panels. The bird stops 110 can help insulate or slow heat transfer directly into the attic space or other interior structure spaces.

A series of apertures or slots can be incorporated in a bird stop, metal sheet or eave closure at a lower eave edge of tile riser or eave riser to allow airflow to enter space under tile but above the supporting roof deck. While bird stop and tile-riser function can be to support the edge of the first course of tile, the added purpose of the vented bird stop is enhanced airflow for moisture mitigation, cooling of roof system components (and/or solar panels) and/or for attic spaces. The apertures or slots are made in the bird stops such that particles (such as embers from fire) ⅛ inch or larger are blocked entry past the bird stop.

Lancing knives 201 (e.g., FIG. 7) can be used to create a vented bird stop. The size and depth of the openings in the bird stops 110 can be uniquely positioned to improve air flow while blocking any ember particle larger than ⅛ inch, as required in wildland urban interface zones. Edges of the bird stops 110 can be contoured to fit the shapes of tile or solar panels. Vent patterns can be varied for aesthetics or airflow performance.

### CLAUSES

Clause 1. A roof component for a roof system having a roof deck that supports roof tiles, the roof component comprising: a bird stop configured to structurally support an underside of a first course of the roof tiles adjacent to an eave of the roof deck, the bird stop is solid and comprises a plurality of apertures, each aperture comprises a through hole and a deformed portion that protrudes from a respective through hole, each through hole comprises a length, a width and a depth, and at least one of the width or the depth comprises a maximum dimension of not greater than ⅛ inch; the bird stop does not include a mesh or backing material adjacent to the apertures; and the bird stop comprises an upper contour that is complementary in shape to the underside of the first course of the roof tiles.
Clause 2. The roof component of clause 1, wherein the roof component does not comprise louvers.
Clause 3. The roof component of clause 1, wherein each of the width and the depth is not greater than ⅛ inch.
Clause 4. The roof component of clause 1, wherein at least one of the width or the depth is not greater than 1/20 inch.
Clause 5. The roof component of clause 1, wherein each deformed portion is open and unobstructed on both sides thereof.
Clause 6. The roof component of clause 1, wherein each deformed portion comprises a trapezoidal or lenticular shape.
Clause 7. The roof component of clause 1, wherein the bird stop comprises a mounting flange at a lower portion thereof that engages and is mounted to the roof deck.
Clause 8. The roof component of clause 1, wherein each deformed portion extends outward, away from the roof tiles toward the eave of the roof deck.
Clause 9. The roof component of clause 1, wherein each deformed portion extends inward.
Clause 10. The roof component of clause 1, wherein the apertures comprise one of: triangular array patterns that are connected by other apertures; triangular array patterns that are not connected by other apertures; staggered, alternating arrays of apertures; an array of rows of apertures that are even; or an array of rows of apertures that are uneven.
Clause 11. A roof system, comprising: a roof deck that supports roof tiles and solar panels; a bird stop coupled to the roof deck to structurally support an underside of a first course of the solar panels or roof tiles adjacent to an eave of the roof deck, the bird stop is solid and comprises a plurality of apertures, each aperture comprises a through hole and a deformed portion protruding from a respective through hole, each through hole comprises a length, a width and a depth, and at least one of the width or the depth comprises a maximum dimension of not greater than ⅛ inch; the bird stop comprises an upper contour that is complementary in shape to the underside of the first course; each deformed portion is open and unobstructed on both sides thereof; and the bird stop does not comprise a mesh or backing material adjacent to the apertures.
Clause 12. The roof system of clause 11, wherein the bird stop does not comprise louvers.
Clause 13. The roof system of clause 11, wherein the depth is not greater than 1/20 inch.
Clause 14. The roof system of clause 11, wherein each of the width and the depth is not greater than ⅛ inch.
Clause 15. The roof system of clause 11, wherein each deformed portion comprises a trapezoidal shape or a lenticular shape.
Clause 16. The roof system of clause 11, wherein the bird stop comprises a mounting flange at a lower portion thereof that is coupled to the roof deck.
Clause 17. The roof system of clause 11, wherein each deformed portion extends outward, away from the roof tiles toward the eave of the roof deck.
Clause 18. The roof system of clause 11, wherein each deformed portion extends inward.
Clause 19. The roof system of clause 11, wherein the apertures comprise one of: triangular array patterns that are continuous with other apertures; triangular array patterns that are not continuous with other apertures; staggered, alternating arrays of apertures; an array of rows and columns of apertures that are even; or an array of rows and columns of apertures that are uneven.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom,” and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

It can be advantageous to set forth definitions of certain words and phrases used throughout this patent document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C.

Also, the use of “a” or “an” is employed to describe elements and components described herein. This is done merely for convenience and to give a general sense of the scope of the invention. This description should be read to include one or at least one and the singular also includes the plural unless it states otherwise.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the specification, skilled artisans will appreciate that certain features which are, for clarity, described herein in the context of separate embodiments, can also be provided in combination in a single embodiment. Conversely, various features that are, for brevity, described in the context of a single embodiment, can also be provided separately or in any sub-combination. Further, references to values stated in ranges include each and every value within that range.

What is claimed is:

1. A roof component fora roof system having a roof deck that supports roof tiles, the roof component comprising:
a bird stop configured to structurally support an underside of a first course of the roof tiles adjacent to an eave of the roof deck, the bird stop is solid and comprises a plurality of apertures, each aperture comprises a through hole and a deformed portion that protrudes from a respective through hole, each through hole comprises a length, a width and a depth, and at least one of the width or the depth comprises a maximum dimension of not greater than ⅛ inch;
the bird stop does not include a mesh or backing material adjacent to the apertures; and
the bird stop comprises an upper contour that is complementary in shape to the underside of the first course of the roof tiles.

2. The roof component of claim 1, wherein the roof component does not comprise louvers.

3. The roof component of claim 1, wherein each of the width and the depth is not greater than ⅛ inch.

4. The roof component of claim 1, wherein at least one of the width or the depth is not greater than 1/20 inch.

5. The roof component of claim 1, wherein each deformed portion is open and unobstructed on both sides thereof.

6. The roof component of claim 1, wherein each deformed portion comprises a trapezoidal or lenticular shape.

7. The roof component of claim 1, wherein the bird stop comprises a mounting flange at a lower portion thereof that engages and is mounted to the roof deck.

8. The roof component of claim 1, wherein each deformed portion extends outward, away from the roof tiles toward the eave of the roof deck.

9. The roof component of claim 1, wherein each deformed portion extends inward.

10. The roof component of claim 1, wherein the apertures comprise one of:
triangular array patterns that are connected by other apertures;
triangular array patterns that are not connected by other apertures;
staggered, alternating arrays of apertures;
an array of rows of apertures that are even; or
an array of rows of apertures that are uneven.

11. A roof system, comprising:
a roof deck that supports roof tiles and solar panels;
a bird stop coupled to the roof deck to structurally support an underside of a first course of the solar panels or roof tiles adjacent to an eave of the roof deck, the bird stop is solid and comprises a plurality of apertures, each aperture comprises a through hole and a deformed portion protruding from a respective through hole, each through hole comprises a length, a width and a depth, and at least one of the width or the depth comprises a maximum dimension of not greater than ⅛ inch;
the bird stop comprises an upper contour that is complementary in shape to the underside of the first course;
each deformed portion is open and unobstructed on both sides thereof; and
the bird stop does not comprise a mesh or backing material adjacent to the apertures.

12. The roof system of claim 11, wherein the bird stop does not comprise louvers.

13. The roof system of claim 11, wherein the depth is not greater than 1/20 inch.

14. The roof system of claim 11, wherein each of the width and the depth is not greater than ⅛ inch.

15. The roof system of claim 11, wherein each deformed portion comprises a trapezoidal shape or a lenticular shape.

16. The roof system of claim 11, wherein the bird stop comprises a mounting flange at a lower portion thereof that is coupled to the roof deck.

17. The roof system of claim 11, wherein each deformed portion extends outward, away from the roof tiles toward the eave of the roof deck.

18. The roof system of claim 11, wherein each deformed portion extends inward.

19. The roof system of claim 11, wherein the apertures comprise one of:
triangular array patterns that are continuous with other apertures;
triangular array patterns that are not continuous with other apertures;
staggered, alternating arrays of apertures;
an array of rows and columns of apertures that are even; or
an array of rows and columns of apertures that are uneven.
